(19) United States
(12) Patent Application Publication
(10) Pub. No.: US 2004/0044686 A1
(43) Pub. Date: Mar. 4, 2004

(54) Information object emulator

(76) Inventor: Shiang-Yu Lee, Seattle, WA (US)

Correspondence Address: Michael S. Smith, Patent Agent, BLACK LOWE & GRAHAM PLLC, 816 Second Avenue, Seattle, WA, 98104, US

(21) Appl. No.: 10/230,801

(22) Filed: Aug. 28, 2002

(51) Int. Cl. G06F 17/00

(52) U.S. Cl. 707/104.1

(57) ABSTRACT

A computer-readable medium and method that allows for efficient and organized storage of an object-oriented data structure. The computer-readable medium stores a data structure that includes a plurality of records. Each record includes a first data field that contains data representing a dependency relationship for each of the records, a second data field that contains data representing a membership relationship for each record, and a third data field that contains data representing a meta-type identity for each record.

### FIELD OF THE INVENTION

This invention relates generally to computer storage data representations and, more specifically, to information objects, relational data structure.

### BACKGROUND OF THE INVENTION

Business information systems are becoming increasingly more complicated. As the complexity of the business information systems grows, so does the complexity of supporting databases and application programs. The complexity grows exponentially with the number of tables in the database. For example, some application programs consist of more than 20,000 tables.

FIG. 1 illustrates a graphical representation of a portion of a database formed in accordance with currently known programming structural rules. Each block represents an object concept with keys (bold text) that provide links to other object concepts and stored information. In memory, each object concept is stored as a unique table. Thus, it can be extremely difficult to understand what each table represents and all the relationship links that associate the tables. Further, designing, maintaining, and upgrading application programs based on these databases require extensive knowledge of the original design in order to make any changes. Consequently, maintaining conventional databases is labor-intensive, time-consuming, and expensive.

Therefore, there exists a need for reducing the complexity of object oriented, relational databases or other computer-based applications.

### SUMMARY OF THE INVENTION

The present invention is a computer-readable medium and method that allows for efficient and organized storage of an information object data structure. According to one exemplary embodiment, the computer-readable medium stores a data structure that includes a plurality of records. Each record includes a first data field that contains data representing a dependency relationship for each of the records, a second data field that contains data representing a membership relationship for each record, and a third data field that contains data representing a meta-type identity for each record.

The records may further include, if desired, a fourth data field containing data representing a semantical definition for the associated record, a fifth data field that contains data representing a unique local record identifier for the associated record, a sixth data field that contains data representing a time of recording of the associated record, and a seventh data field that contains data representing validity of the associated record.

The records may also further include, if desired, an eighth data field that contains data representing a value for the associated record. The value suitably includes at least one of a string, reference, integer number, real number, monetary number, Boolean, date time, date, time duration, text, or random number values.

The records may further include, if desired, another data field that contains data representing a metadata value for the associated record. The metadata value suitably includes at least one of a security level, synonym, sequence, distinction, expression up, expression down, qualifier, definition context, executable code, or executable source code values.

### BRIEF DESCRIPTION OF THE DRAWINGS

The preferred and alternative embodiments of the present invention are described in detail below with reference to the following drawings.

FIG. 1 is a graphical representation of a prior art database;

FIG. 2 is a graphical representation of record relationships according to the present invention;

FIG. 3 is a flow diagram of a routine according to the present invention; and

FIGS. 4A and B illustrate an example table with records with fields formed in accordance with the present invention.

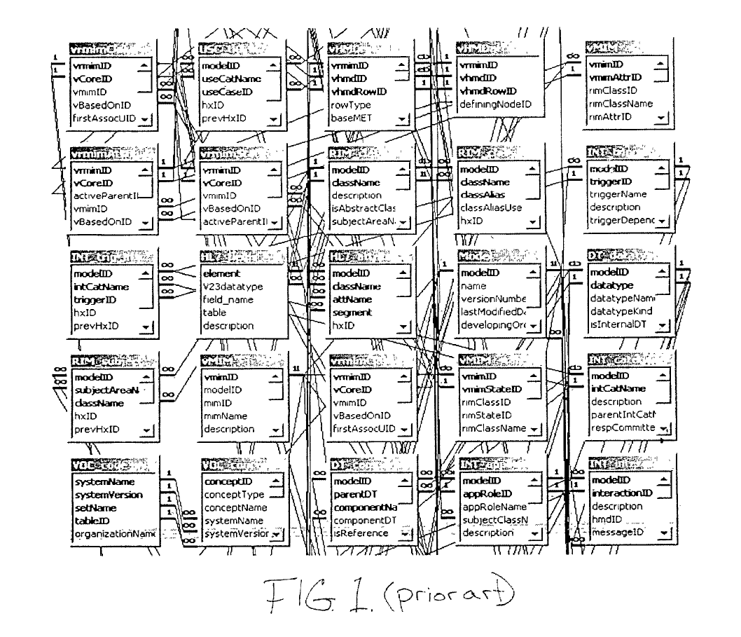

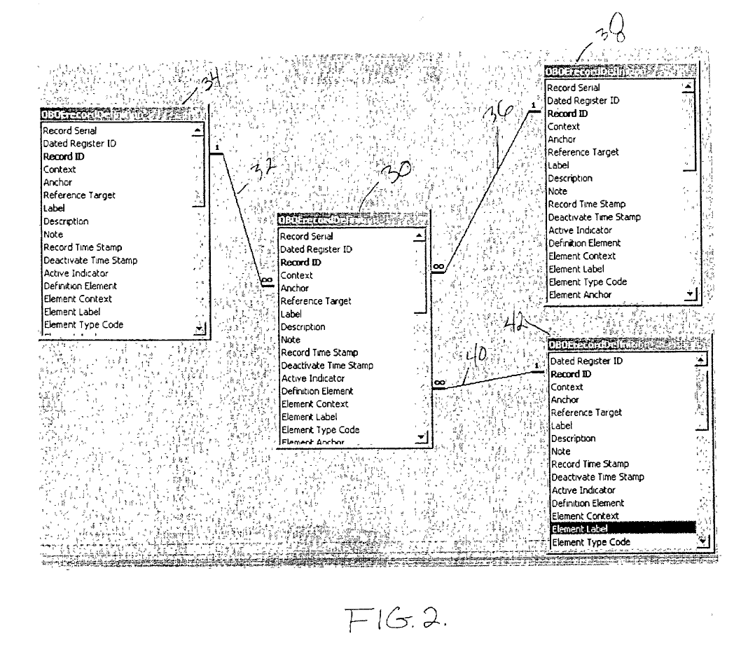

### DETAILED DESCRIPTION OF THE INVENTION

The present invention provides a computer-based information storage organization scheme. The scheme includes one format with enough semantic information to construct any type of complex information. The one format minimizes data processing complexity for applications and for exchanging information between computer applications.

FIG. 2 illustrates records and basic structural relationships that each record includes in one presently preferred embodiment of the present invention. As shown in FIG. 2, a record 30 has a first relationship 32 to another record 34 that anchors the record 30 to the other record 34 by associating the record identification (ID) of the record 34 to an anchor component of the first record 30. The first relationship 32 defines the first record 30 as being dependent from the record 34. A second relationship 36 establishes the membership of the record 30 to another record 38. The record ID of the record 38 that establishes the membership relationship for the record 30 is identified in a context component of the record 30. A third relationship 40 establishes a meta-type identity associated with the record 30. A definition element component of the record 30 includes the record ID of a meta-type record 42. The relationships described above allow a user of the database, or a person not familiar with initial development of the database, to know and understand the relationships and meanings of the relationships of records within the database, to easily find information in the database, and to easily understand the information in the database. The relationships described above and other optional structural information is described in more detail below.

One presently preferred embodiment of the present invention describes a single linear record format with predefined fields for data exchange, file storage implementation, database implementation, or programming in-memory data storage and access. The single linear record format represents an “irreducible” record design standardizing all data representations. The record format suitably includes without limitation at least some of the following format items:

1. A locally unique Record Identifier (RI) (String);

2. A Record Semantics reference field (RS), pointing to a record which contains the semantical definition of the current record;

3. A Dependency field (DP) with value equal to another RI establishing an existence dependency between records. Two specific records in each implementation can point to each other, one signifying the “implementation” (Implementation Identity, II) and the other representing the organization responsible for the implementation (Organizational Identity, OI). All other “independent” records must point to the II. The OI and/or II can be registered with an international authority as a universally unique identifier, similarly to the way Universal Resource Locators (URL) are registered (String);

4. A Meta-type Identity (MI) field which qualifies the characterization of the record (String). MI's identify the “record type” as described in the next paragraph text marked by “Note: MI”;

5. A Time Stamp (TS) field that keeps track of the time of recording the record (Time);

6. An optional Name Label (NL) field that provides readable identification of the record (String);

7. An Active Indication (AI) field indicates the record is currently valid (Boolean);

8. An optional Archive Log (AL) field records time of deactivation (Time);

9. An optional Index field (IX) establishing the sequencing of records in storage (Index);

10. An optional Computer Stored Object (CSO) file pointer (Hot Link, including URI) (Pointer String);

11. A group of selective fields VF (used one at a time) to store the “value” of the intended record, including the following types:

Binary (BNR)

String (STR)

Reference (RFC)

Integer Number (INT)

Real Number (RNM)

Monetary Number (MNY)

Boolean (BLN)

Date Time (DTM)

Date (DTE)

Time Duration (TDR)

Text (simple formatted long text, can have multiple paragraphs) (TXT)

Derived Number (RNM);

12. A group of optional fields used only when the record is of the “Definition” type, or metadata.

Security Level (SL, String)

Synonym (String)

Sequence (Integer)

Distinction (Text)

Expression Up (String)

Expression Down (String)

Qualifier (String)

Definition Context (String)

Executable (Complied computer code) (Binary)

Exec Source (Source code for Executable) (Text);

13. An optional Description field (DCS) storing the definition/description of the recorded object;

14. An optional Note field (NTE) with additional information about the recorded object; and

15. A Host Object field (HOB) establishing the membership of each entry record to the object it belongs to.

The following are suitable record types (Note: MI) that can be identified using the record format described above:

1. An Object Existence Record (OER) establishing the existence of an object instance in the current implementation. This record type is constructed with a Meta-type Identity (MI) entry using a symbol representing the Object Existence Record type.

2. For each Object, there will also be at least one record of Element Entry Record (EER). An EER is an actual instance record of one information unit of the Object. Each EER must “correspond” to (conform) one specific Definition Record. EER is the generalized reference of internal entry records of an object, including without limitation the following types:

a. A Class Instance Record (CIR) that is a class occurrence record to identify class membership of an object. For each Class Instance Record (CIR), there is a corresponding Class End Record (CER). The CIR type is constructed with a Meta-type Identity (MI) entry using a symbol representing the Class Instance Record type;

b. A Structure Instance Record (SIR) that is a component member of the object that does not exist independently, but it can by itself assume the role of an elementary data value record. For each SIR, there is also a corresponding Structure End Record (SER). The SIR record type is constructed with a Meta-type Identity (MI) entry using a symbol representing the Structure Instance Record type;

c. A Data Value Record (DVR) recording the value of information stored. The DVR is suitably subordinate to a Class or a Structure. The DVR record type is constructed with a Meta-type Identity (MI) entry using a symbol representing each different subtype of Data Value Record type as identified in (11) above; and

d. A Definition Source Reference (DSR) that points to an external source of record type definitions. The DSR record type is constructed using a symbol representing the link location data type supported by the operating system.

The record format is used to store object definition information, also known as Metadata, or Schema Definitions. The following are Element Definition (ED) record types constituting a Schema Definition.

1. A Schema Instance Record (SCR) identifying a unique set of definitions.

2. A Language Reference Record (LRR) pointing to a language defined in a Language Definition Schema.

3. A Schema Type Record (STR) to indicate the type of the Schema functionality. Schemas can be Base Definition or View Definition Types.

4. A Class Definition Record (CDR) defining a class within a schema, with a corresponding End Class record.

5. A Structure Definition Record (SDR) defining a structure record within the schema, with a corresponding End Structure record.

6. A Class Relation Definition (CRD) relating two classes in the schema as general concept/specific concept relationship.

7. An Exclusive Typing Record (ETR) to provide indication that certain Class Relation Definition follow a “mutually exclusive” rule.

8. A Value Record Type Definition (VRT) to identify the type of each Data Value Record.

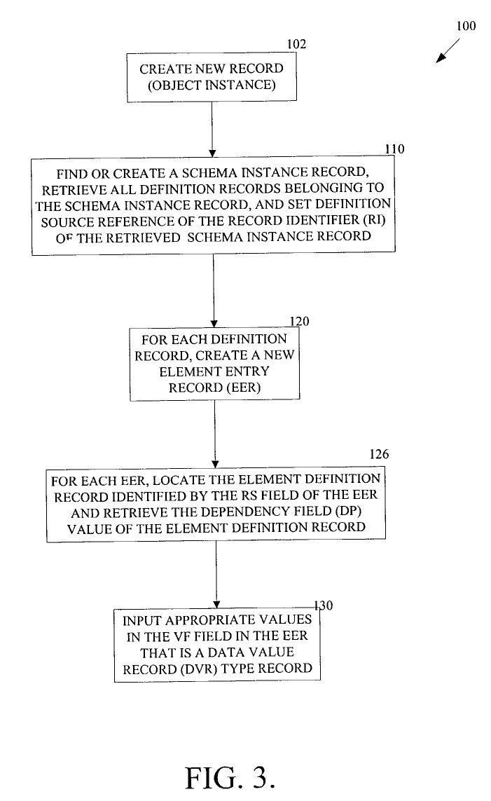

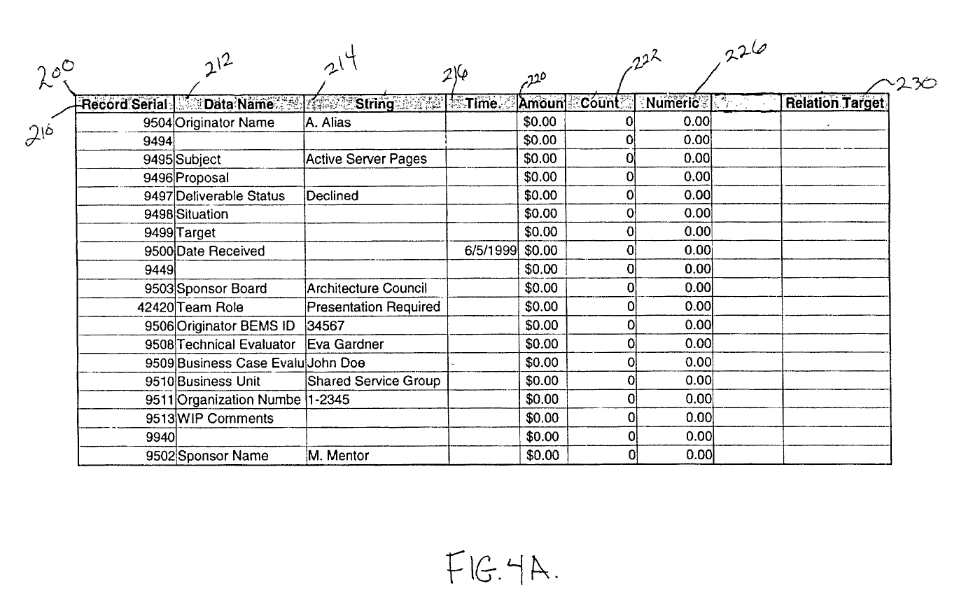

FIG. 3 illustrates one presently preferred process 100 for entering information according to the record format described above. At a block 102, an Object Instance is initiated by creating a new record in the implementation and inputting a new unique Record ID. A Time Stamp is set to the current time to mark time of creation. A name to the Object Instance is entered in the Name Label field. An Active Indicator is set to “Yes.” A Dependency field is set to the value of RI for the “Implementation Identity” (II) Object in the same database.

At a block 110, a Schema Instance record is located, if one already exists. Otherwise, a Schema Instance record is created. All the Definition Records (DR) belonging to the Schema Instance record are retrieved. An Object Instance “Definition Source Reference” is set to the value of the RI of the Schema Instance record.

At a block 120, for each DR of the Schema Instance record, a new EER is created with its own unique Record ID. A DR Record ID is copied into the MI field, and the corresponding RS value is copied into the RS field. For all the CDRs, the corresponding CDR record instance has the DP field set to the value of the Object ID. For all the SDRs, the corresponding SIR record instance sets its DP field to the corresponding CDR Record ID. For all the VRTs, the corresponding DVR record instance sets its DP field to the corresponding CDR or SDR Record ID.

At a block 126, for each EER, the Element Definition record identified by the RS field is located, the value of the DP field is retrieved. Given DP1, the DP field value is compared to the current set of EER and the corresponding record with the RS value equal to DP1 is found. The Record ID (RI) of the Element Definition record is read, and the value in the DP field of the current EER is stored. At a block 130, the appropriate value of VF field is inputted in the EER record, which is of DVR type. The result is a simple association between components that can be easily listed in a single table and easily reviewed and analyzed.

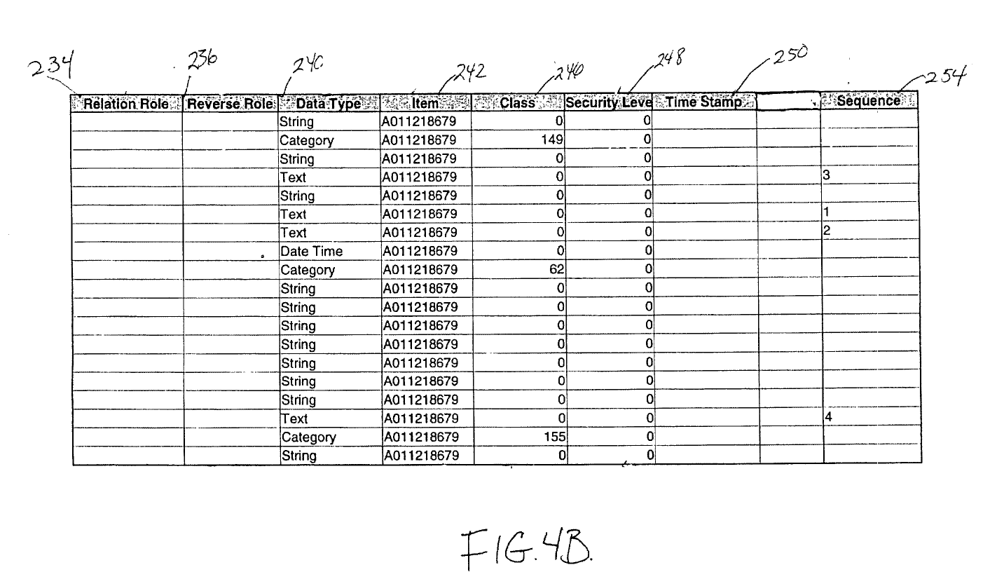

FIGS. 4A and 4B illustrate an example table that is created using the record format as described above. Each record is identified by a row of information in a table 200. The table 200 includes columns that allow for the storage of various types of information. It wil be appreciated that not all the columns need be used for each record. Instead, only those columns that are associated with that record are suitably used. The table 200 includes a record serial column 210 that identifies a record identifier for each record. The table 200 also includes a data name column 212 that includes an optional name label field, a string column 214, a time column 216, an amount column 220, a count column 222, and a numeric column 226 that include information that is entered into a group of selected fields VF for the record, as shown in record item 11 of the record format above. A relation target column 230 is the dependency field (3) for each record.

Referring to FIG. 4B, a relation role column 234 and a reverse role column 236 receive expression up and expression down string information for the record, as shown in the format item 12 of the record format. A data type field 240 includes the meta-type identity of the record, as shown in the format item 4 of the record format. An item column 242 is the host object field for the associated record, as shown in the format item 15 of the record format. A class column 246 includes record semantics information for the record as shown in the format item 2 of the record format. The security level column 248 includes security level information for the record, as shown in the format item 12 of the record format. A time stamp column 250 includes time stamp information for the record, as shown in the format item 5 of the record format. A sequence column 254 is an index field for the record, as shown in the format item 9 of the record format.

With the data record formats and types as described and method of construction implemented, a computer application system of this invention is capable of recording the initiation of an information object emulating the existence of a true object in the world. As the object evolves in its life, all the changes are captured by deactivating some records and adding others while the identity of the object remains the same, until its demise. In this sense, the application system is a registry and repository of all relevant information objects and historical archive.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A computer-readable medium having stored thereon a data structure including a plurality of records, the computer-readable medium comprising:
a first data field containing data representing a dependency relationship for each of the records;
a second data field containing data representing a membership relationship for each record; and
a third data field containing data representing a meta-type identity for each record.

2. The computer-readable medium of claim 1, further comprising a fourth data field containing data representing a semantic definition for an associated record.

3. The computer-readable medium of claim 2, further comprising a fifth data field containing data representing a unique local record identifier for the associated record.

4. The computer-readable medium of claim 3, further comprising a sixth data field containing data representing a time of recording the associated record.

5. The computer-readable medium of claim 4, further comprising a seventh data field containing data representing validity of the associated record.

6. The computer-readable medium of claim 5, further comprising an eighth data field containing data representing a value for the associated record.

7. The computer-readable medium of claim 6, wherein the value includes at least one of a string, reference, integer number, real number, monetary number, Boolean, date time, date, time duration, text, or random number values.

8. The computer-readable medium of claim 5, further comprising an eighth data field containing data representing a metadata value for the associated record.

9. The computer-readable medium of claim 8, wherein the metadata value includes at least one of a security level, synonym, sequence, distinction, expression up, expression down, qualifier, definition context, executable code, or executable source code values.

10. The computer-readable medium of claim 5, further comprising an eighth data field containing data representing at least one of a name label, archive value, definition, or note for the record.

11. A method for organizing an object-oriented data structure that includes a plurality of records, the method comprising:
defining an anchoring relationship for one or more of the records, wherein the anchoring relationship defines a dependency relationship for the one or more records;
defining a membership relationship for the one or more records; and
identifying a meta-type identity for the one or more records.

12. The method of claim 11, further comprising defining a semantic definition for the one or more records.

13. The method of claim 12, further comprising defining a unique local record identifier for the one or more records.

14. The method of claim 13, further comprising defining a time of recording the one or more records.

15. The method of claim 14, further comprising defining validity of the one or more records.

16. The method of claim 15, further comprising defining a value for the one or more records.

17. The method of claim 16, wherein the value includes at least one of a string, reference, integer number, real number, monetary number, Boolean, date time, date, time duration, text, or random number values.

18. The method of claim 15, further comprising defining a metadata value for the one or more records.

19. The method of claim 18, wherein the metadata value includes at least one of a security level, synonym, sequence, distinction, expression up, expression down, qualifier, definition context, executable code, or executable source code values.

20. The method of claim 15, further comprising defining at least one of a name label, archive value, definition, or note for the one or more records.

21. A system including a processor computer-readable medium having stored thereon a data structure including a plurality of records, the system comprising:
a processor; and
memory coupled to the processor, the memory including a data structure with a plurality of records, the data structure includes:
a first data field containing data representing a dependency relationship for each of the records;
a second data field containing data representing a membership relationship for each record; and
a third data field containing data representing a meta-type identity for each record.

22. The system of claim 21, wherein the data structure further comprises a fourth data field containing data representing a semantic definition for an associated record.

23. The system of claim 22, wherein the data structure further comprises a fifth data field containing data representing a unique local record identifier for the associated record.

24. The system of claim 23, wherein the data structure further comprises a sixth data field containing data representing a time of recording the associated record.

25. The system of claim 24, wherein the data structure further comprises a seventh data field containing data representing validity of the associated record.

26. The system of claim 25, wherein the data structure further comprises an eighth data field containing data representing a value for the associated record.

27. The system of claim 26, wherein the value includes at least one of a string, reference, integer number, real number, monetary number, Boolean, date time, date, time duration, text, or random number values.

28. The system of claim 25, wherein the data structure further comprises an eighth data field containing data representing a metadata value for the associated record.

29. The system of claim 28, wherein the metadata value includes at least one of a security level, synonym, sequence, distinction, expression up, expression down, qualifier, definition context, executable code, or executable source code values.

30. The system of claim 25, wherein the data structure further comprises an eighth data field containing data representing at least one of a name label, archive value, definition, or note for the record.

31. The system of claim 25, wherein all records with active indication field being true represent the current state of the system.

32. The system of claim 31, wherein all records with active indication field being false represent the history of the system.
